(19) United States
(12) Patent Application Publication
(10) Pub. No.: US 2022/0414647 A1
(43) Pub. Date: Dec. 29, 2022

(54) PERSONAL CARD MANAGEMENT SYSTEM AND METHOD BY REVERSE AUTOMATIC SYNCHRONIZATION

(71) Applicant: E4NET CO., LTD, Seoul (KR)

(72) Inventor: Su Jeong Lee, Seoul (KR)

(21) Appl. No.: 17/851,032

(22) Filed: Jun. 28, 2022

(30) Foreign Application Priority Data
Jun. 28, 2021 (KR) 10-2021-0083727

(51) Int. Cl. G06Q 20/34; G06Q 20/38

(52) U.S. Cl. CPC G06Q 20/346; G06Q 20/389

(57) ABSTRACT

Disclosed are a personal card management system and method by reverse automatic synchronization. The personal card management system by reverse automatic synchronization comprises: a public interest corporation terminal which designates a beneficiary for facilitating the benefits of donations and provides a card company system with deposits; a card management server which registers the card of the beneficiary designated by the public interest corporation terminal and manages the transaction history of the registered card; and a beneficiary terminal which requests the registration of the card for receiving the benefits to the card management server and synchronizes the relevant transaction history with the card management server.

### TECHNICAL FIELD

The present invention relates to a personal card management system and a method thereof, and more specifically, to a personal card management system and a method thereof by reverse automatic synchronization.

### BACKGROUND ART

With the prior art, there were difficulties associated with processing, generating, or checking data on a card's transaction history when calculating business expenses or on the card's transaction history of donations, so those processes had to be manually completed.

When you receive your card transaction history from the card company's system, you must receive all data without selecting a certain period or date or the like and must manually process the card transaction history to calculate the expenses and the usage of benefits.

In addition, public interest corporations and companies or the like providing donations also have problems precisely checking the card transaction history including donation usage and expenses, which create an obstacle to making donations and places a much greater burden on companies for calculating expenses.

### PRIOR ART LITERATURE

### Patent Literature

(Patent Literature 1) Korean Patent No. 10-1854393

(Patent Literature 2) Korean Patent No. 10-1219027

### DETAILS OF THE INVENTION

### Problem to be Solved

The present invention aims to provide a personal card management system by reverse automatic synchronization.

The present invention aims to provide a personal card management method by reverse automatic synchronization.

### Solution

To this end, in accordance with the present invention, the personal card management system by reverse automatic synchronization can be configured to comprise: a public interest corporation terminal which designates a beneficiary for facilitating the benefits of donations and provides a deposit to a card company system; and a card management server which registers the card of the beneficiary designated by the public interest corporation terminal and manages the transaction history of the registered card.

Here, the personal card management system by reverse automatic synchronization can be configured to additionally comprise a beneficiary terminal which requests the registration of the card for receiving the benefits to the card management server and synchronizes the relevant card transaction history with the card management server.

The beneficiary terminal can be configured to automatically request the personal transaction history to the card company system after the consent to the provision of personal information on a regular basis or at the time of logging in and transmit the received information immediately to the card management server. The card management server can be configured to use, renew, and modify the relevant transaction history, and reversely transmit the card transaction history to the beneficiary terminal. The beneficiary terminal can be configured to receive the card transaction history from the card management server, and store and keep the history.

In addition, the beneficiary terminal can be configured to, when requesting the personal transaction history to the card company system, automatically set a request period from after a time stored in the card transaction history information to the current time without a separate setting, and automatically transmit all the information received from the card company system to the card management server without a separate modification or storage action.

In addition, the beneficiary terminal can be configured to perform the reverse automatic synchronization on the personal card transaction history by renewing and storing the synchronization information transmitted from the card management server after receiving the information.

In addition, the beneficiary terminal can be configured to, when the beneficiary modifies the personal card transaction history through the synchronized personal card transaction history, transmit the personal card transaction history to the card management server to request synchronization, and perform the reverse automatic synchronization on the personal card transaction history by a method of retransmitting and renewing the card transaction history information from the card management server.

In accordance with another purpose of the present invention above, the personal card management method by reverse automatic synchronization can be configured to comprise: a step in which the public interest corporation terminal designates and registers a beneficiary on the card management server for facilitating the benefits of donations and provides the deposit to the card company system; a step in which the beneficiary terminal requests the registration of the card for receiving the benefits to the card management server; and a step in which the card management server registers the card in accordance with the request for registration and maintains the reverse automatic synchronization on the transaction history of the registered card.

Here, the public interest corporation terminal can be configured to additionally comprise a step in which the public interest corporation terminal additionally pays, calculates and recollects the deposits facilitated as benefits based on the synchronized card transaction history.

### Effects of the Invention

In accordance with the personal card management system and method by reverse automatic synchronization above, the system and method are configured to automatically manage and synchronize the card transaction history of donation benefits or the card transaction history of the expenses by the company thereby allowing the public interest corporation or the donor to precisely check the benefits usage history of the beneficiary and to precisely check and process the usage history including company expense processing and cash calculation or the like for the personal card registered on the card management server.

In the case of the benefits usage history, it is not necessary for the public interest corporation to report the benefits history to the donor manually, and the donor can automatically check how his/her donations are used based on each usage history, so the information about the user and the usage history of donations is transparently provided, thereby promoting donations.

### BRIEF DESCRIPTION OF THE DRAWINGS

FIG. 1 is a block diagram of the personal card management system by reverse automatic synchronization in accordance with an embodiment of the present invention.

FIG. 2 is an example drawing of a usage history checking screen of benefits in accordance with an embodiment of the present invention.

FIG. 3 is a flowchart of the personal card management method by reverse automatic synchronization in accordance with an embodiment of the present invention.

### SPECIFIC DETAILS FOR IMPLEMENTING THE INVENTION

The present invention may have various changes and diverse embodiments, so it is intended to show specific embodiments in the drawings and describe the specific details for implementing the present invention. However, this is not intended to limit the present invention to a specific embodiment but must be understood to include all changes, equivalences or substitutions included in the idea and technical scope of the present invention. While describing each drawing, similar reference symbols are used for similar components.

Terms such as a first, second, A, and B can be used for describing various components, but such components must not be limited by the terms. The above terms are used only for distinguishing a single component from other components. For instance, a first component can be named as a second component without exceeding the scope of right of the present invention, and likewise, the second component can also be named as the first component. The term “and/or” includes a combination of a plurality of related written items or one from the plurality of related written items.

When it is mentioned that a component is “connected to” or “accessed by” another component, it must be understood that the component may be directly connected or accessed to the other component, but that any other component may exist in the middle. On the other hand, when it is mentioned that a component is “directly connected to” or “directly accessed by” another component, it must be understood that no other component exists in the middle.

The terms used in the present invention are used just for describing specific embodiments and are not intended to limit the present invention. An expression of a single number includes an expression of a plural number unless it is clearly otherwise meant in the context. In the present invention, terms such as “comprise” and “have” must be understood to designate the existence of characteristics, numbers, steps, operations, components, parts, or combinations of those written in the specifications but not to exclude in advance the existence or possibility of the addition of one or more other characteristics, numbers, steps, operations, components, parts, or combinations of those.

Unless otherwise defined, all terms used herein including technological or scientific terms have the same meaning as the general understanding of persons of ordinary skill in the pertinent art in the technical field to which the present invention belongs. Those terms that are the same as those defined in the dictionary used in general must be interpreted to have the same meaning as the meaning of the related technology in the context, and unless clearly defined in the present invention, those terms are not interpreted to have an ideal or excessively formative meaning.

Hereinafter, desirable embodiments of the present invention are described in detail by referring to the attached drawings.

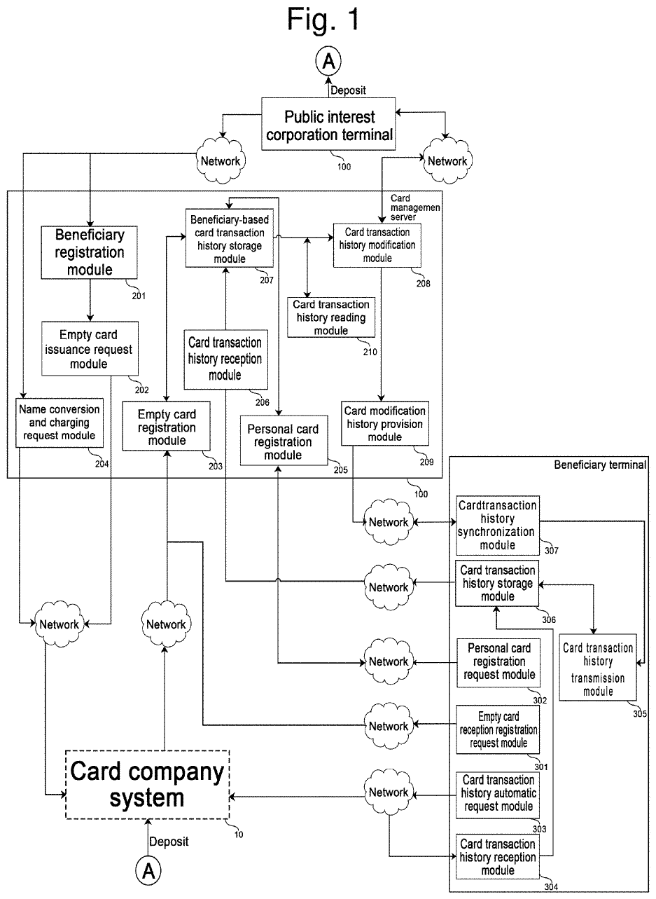

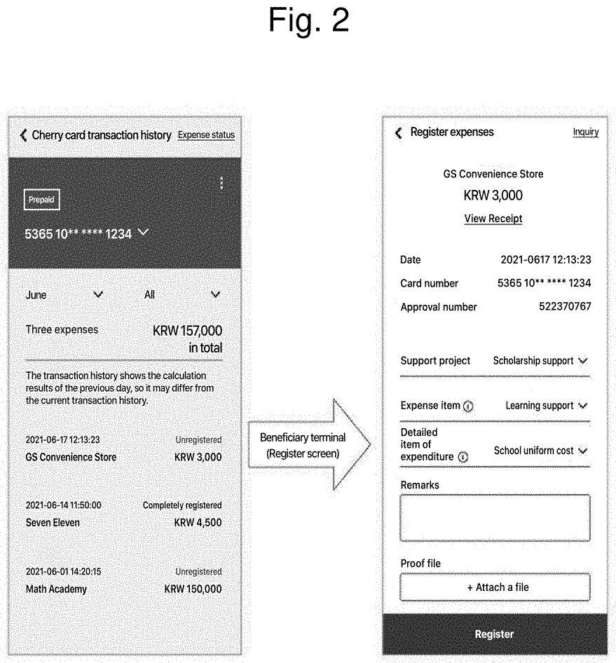

FIG. 1 is a block diagram of the personal card management system by reverse automatic synchronization in accordance with an embodiment of the present invention. FIG. 2 is an example drawing of a usage history checking screen of benefits in accordance with an embodiment of the present invention.

Referring to FIG. 1, the personal card management system by automatic synchronization in accordance with an embodiment of the present invention can be configured to comprise: a public interest corporation terminal (100); a card management server (200); and a beneficiary terminal (300).

Hereinafter, the detailed configuration is described.

The public interest corporation terminal (100) is a terminal of a public interest corporation which provides several beneficiaries with donations or the like.

The public interest corporation terminal (100) can be configured to designate a beneficiary for facilitating the benefits of donations and provide the card company system (10) with deposits.

The card management server (200) is configured to manage the card transaction history of each beneficiary for the management of the card transaction history of executives and staff for processing expenses of an enterprise or for the implementation of donations of a public interest corporation. In addition, it can be configured to manage the card transaction history of various government support funds. All the cases, when the beneficiary or the individual does not in person pay for the card payments but processes the payment as the expenses of a public interest corporation, government, company or the like, can fall under this category.

The card management server (200) can be configured to designate a card of the beneficiary designated by the public interest corporation terminal (100) and manage the transaction history of the designated card.

The card management server (200) can be configured to comprise: a beneficiary registration module (201); an empty card issuance request module (202); an empty card registration module (203); a name conversion and charging request module (204); a personal card registration module (205); a card transaction history reception module (206); a beneficiary-based card transaction history reception module (207); a card transaction history modification module (208); and a card transaction history modification provision module (209).

Hereinafter, the detailed configuration is described.

The beneficiary registration module (201) can be configured to receive the beneficiary from the public interest corporation terminal (100) and register the beneficiary.

The empty card issuance request module (202) can be configured to request the issuance of the empty card for the beneficiary registered on the beneficiary registration module (201) to a card company system (10). The card company system (10) can be configured to issue an empty card and deliver the empty card from the card company to the relevant beneficiary.

The empty card registration module (203) can be configured to register the empty card issued in accordance with the request of the empty card issuance request module (202) based on the request of the beneficiary terminal (300). The beneficiary can receive the empty card from the card company.

The name conversion and charging request module (204) can be configured to request the card company system (10) of converting the name of the empty card registered by the empty card registration module (203) into the name of the beneficiary registered by the beneficiary registration module (201) and of charging the card. In addition, the card company can be configured to receive deposits from the public interest corporation, company, or government to the account and charge the deposits in the empty card.

The personal card registration module (205) can be configured to receive and register a personal card possessed by the beneficiary from the beneficiary terminal (300). Even if the empty card is not separately issued, the personal card of the beneficiary can be registered on the card management server (200) for managing the card transaction history such as expenses, benefits, and donations.

The card transaction history reception module (206) can be configured to receive the card transaction history of the empty card registered by the empty card registration module (203) or the personal card registered by the personal card registration module (205) from the beneficiary terminal (300). Here, the beneficiary terminal (300) automatically requests the card company system (10) for the personal transaction history after receiving consent to provide the personal information from the beneficiary at the time of logging in, and transmits the received information immediately to the card management server (200). The card management server (200), which has received the transaction history, reversely transmits the card transaction history to the beneficiary terminal (300) after renewing and modifying the transaction history. The beneficiary terminal (300) manages the personal card transaction history by reverse automatic synchronization by storing and keeping the data in the card management server (200).

The beneficiary-based card transaction history storage module (207) can be configured to store the card transaction history received by the card transaction history reception module (206) for each beneficiary.

The card transaction history modification module (208) can be configured to modify the card transaction history of each beneficiary stored in the beneficiary-based card transaction history storage module (207) in accordance with the input of a manager terminal (the company or a government agency) or a public interest corporation terminal (100).

The card transaction history reading module (210) can be configured to automatically and separately read the expenses history, benefits usage history, or donations usage history from the card transaction history of each beneficiary.

Here, the card transaction history reading module (210) can be configured to automatically read the expenses history, benefits usage history, or donations usage history by using the usage history category or the uses which were previously received from the public interest corporation terminal (100) or the government agency terminal (not shown) as well as the expenses history and date.

The card transaction history modification module (208) can be configured to check and modify the expenses history, benefits usage history or donations usage history which are automatically read by the card transaction history reading module (210). Modification can be made by an input of the company terminal (not shown), the public interest corporation terminal (100), and/or the government agency terminal (not shown).

The public interest corporation terminal (100) is able to provide the relevant donor's donor terminal (not shown) with the benefits usage history and notify the donor how his/her donations are used in real-time. FIG. 2 is an application screen that lets the donor know the benefits usage history.

The card transaction history modification provision module (209) can be configured to provide the manager terminal (the company or the government agency) or the public interest corporation terminal (100) with the card transaction history modified by the card transaction history modification module (208) in real-time.

Meanwhile, the donations-deposits mapping module (not shown) can be configured to map the donations and the deposits of the donor.

In addition, the donor notification module (not shown) can be configured to provide the donor's donor terminal (not shown) with the card transaction history corresponding to the deposits mapped by the donations-deposits mapping module (not shown) in real-time. Through the screen as shown in FIG. 2, the donor can check how his/her donations are used in real-time.

The beneficiary can receive donations by using his/her personal card instead of receiving benefits in cash thereby enhancing convenience. The donor can be provided with transparency on the uses of his/her donations allowing the process to be operated as a virtuous circle.

Through this process, the usage history of expenses, donations, and support funds can be transparently tracked, and the beneficiary, company, public interest corporation, agency, or the like can very conveniently perform work such as processing expenses and using donations and support funds or the like and enhance the accuracy.

The beneficiary terminal (300) is a terminal of the beneficiary who receives the donations of the public interest corporation. The term “beneficiary” hereby includes all executives and staff of the company and the beneficiaries of government support funds as well as the beneficiaries of donations.

The beneficiary terminal (300) can be configured to register a card for receiving benefits on the card management server and synchronize the relevant transaction history with the card management server (200).

The beneficiary terminal (300) can be configured to comprise: an empty card registration request module (301); a personal card registration request module (302); a card transaction history automatic request module (303); a card transaction history reception module (304); a card transaction history storage module (305); a card transaction history transmission module (306); and a card transaction history synchronization module (307).

Hereinafter, the detailed configuration is described.

The empty card registration request module (301) can be configured to request the registration of the empty card issued by the card company system (10) to the card management server (200) in accordance with the request of the empty card issuance request module (301). Here, the beneficiary can receive the empty card from the card company.

The personal card registration request module (302) can be configured to request the registration of the personal card possessed by the beneficiary to the card management server (200).

The card transaction history automatic request module (303) can be configured to automatically request the transaction history of the empty card or the personal card to the card company system (10) after receiving consent from the beneficiary to provide personal information on a regular basis or at each time of logging in. Here, the request period is automatically set to be from the point after the time of the card transaction history information stored to the current time without a particular setting, and all information received from the card company system (10) is automatically transmitted to the card management server (200) without a particular modification or storage action.

The card transaction history reception module (304) is configured to transmit the card transaction history in accordance with the automatic request of the card transaction history automatic request module (303) to the card management server through the card transaction history transmission module (306) immediately after receiving the card transaction history from the card company system (10).

The card transaction history storage module (305) can be configured to store the card transaction history received from the card transaction history synchronization module (307).

The card transaction history transmission module (306) can be configured to transmit the history modified by the beneficiary among the card transaction history stored in the card transaction history storage module (305) to the card management server (200).

The card transaction history synchronization module (307) can be configured to receive the card transaction history from the card management server (200) and renew the received card transaction history in the card transaction history storage module (305) for the reverse automatic synchronization. That is, the modifications are synchronized and stored in the card transaction history storage module (305), and the beneficiary can also check which of the card transaction history entries is a benefits usage history, donations usage history, or expenses processing history. The beneficiary can check if all the benefits or support funds allocated to himself/herself are properly used or not and check if the expenses are processed properly or not.

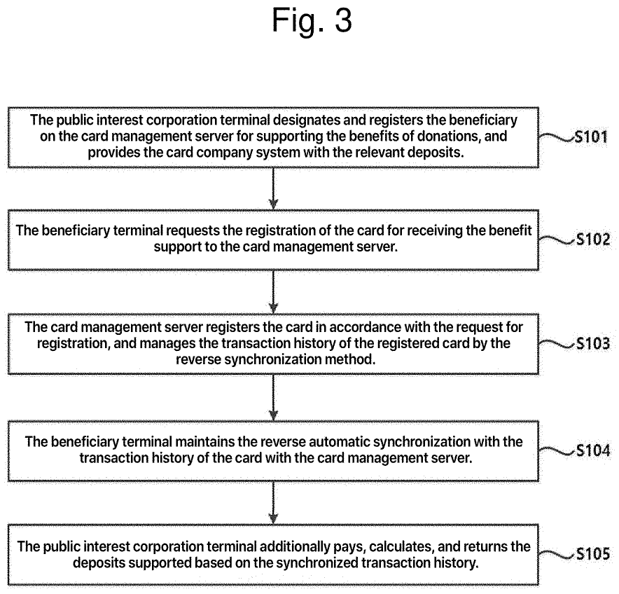

FIG. 3 is a flowchart of the personal card management method by reverse automatic synchronization in accordance with an embodiment of the present invention.

Referring to FIG. 3, the public interest corporation terminal (100) designates and registers the beneficiary on the card management server (200) for facilitating the benefits of donations and provides the card company system (10) with the relevant deposits (S101).

Next, the beneficiary terminal (300) requests the registration of the card for receiving the benefits to the card management server (200) (S102).

Next, the card management server (200) registers the card in accordance with the request for registration and manages the transaction history of the registered card (S103).

Next, the beneficiary terminal (300) synchronizes (S104) the transaction history of the card with the card management server (200).

Next, the public interest corporation terminal (100) additionally pays, calculates and returns the deposits facilitated as benefits based on the synchronized transaction history (S105).

As such, the present invention is described by referring to the embodiments, but any skilled person in the same industry in the relevant technical field would be able to understand that the present invention can be variously modified and changed within the scope that does not exceed the idea and area of the present invention written in the below scope of the claim for the patent.

### DESCRIPTION OF SYMBOLS

100: Public interest corporation terminal

200: Card management server

201: Beneficiary registration module

202: Empty card issuance request module

203: Empty card registration module

204: Name conversion and charging request module

205: Personal card registration module

206: Card transaction history reception module

207: Beneficiary-based card transaction history storage module

208: Card transaction history modification module

209: Card transaction history modification provision module

210: Card transaction history reading module

300: Beneficiary terminal

301: Empty card registration request module

302: Personal card registration request module

303: Card transaction history automatic request module

304: Card transaction history reception module

305: Card transaction history storage module

306: Card transaction history transmission module

307: Card transaction history synchronization module

1. The personal card management system by reverse automatic synchronization comprises:
a public interest corporation terminal which designates a beneficiary for facilitating the benefits of donations and provides a card company system with deposits;
a card management server which registers the card of the beneficiary designated by the public interest corporation terminal and manages the transaction history of the registered card; and
a beneficiary terminal which requests the registration of the card for receiving the benefits to the card management server and synchronizes the relevant transaction history with the card management server,
wherein the card management server comprises:
a beneficiary registration module which receives and registers the beneficiary from the public interest corporation terminal;
an empty card issuance request module which requests the issuance of an empty card for the beneficiary registered by the beneficiary registration module to the card company server;
an empty card registration request module which registers an empty card issued in accordance with the request of the empty card issuance request module based on the request of the beneficiary terminal;
a name conversion and charging request module which requests the name conversion into the name of the beneficiary registered by the beneficiary registration module and charging of the empty card registered by the empty card registration module to the card company server for the registered empty card;
a personal card registration module which receives and registers the personal card possessed by the beneficiary from the beneficiary terminal;
a card transaction history reception module which receives the card transaction history of the empty card registered by the empty card registration module or the personal card registered by the personal card registration module from the beneficiary terminal;
a beneficiary-based card transaction history storage module which stores the card transaction history received from the card transaction history reception module for each beneficiary;
a card transaction history reading module which automatically and separately reads the expenses history, benefits usage history, or donations usage history from the card transaction history of each beneficiary stored in the beneficiary-based card transaction history storage module;
a card transaction history modification module which modifies the card transaction history of each beneficiary stored in the beneficiary-based card transaction history storage module in accordance with an input of a manager terminal or a public interest corporation terminal; and
the card transaction history modification provision module which provides the relevant beneficiary terminal with the card transaction history modified by the card transaction history modification module,
wherein the beneficiary terminal comprises:
an empty card registration request module which requests the registration of the empty card issued by the card company server to the card management server in accordance with the request of the empty card issuance request module;
a personal card registration request module which requests the registration of the personal card possessed by the beneficiary to the card management server;
a card transaction history automatic request module which automatically requests the transaction history of the empty card or the personal card to the card company server on a regular basis or at each time for logging in by the beneficiary;
a card transaction history reception module which receives the card transaction history in accordance with the automatic request of the card transaction history automatic request module from the card company server;
a card transaction history storage module which stores the card transaction history received from the card transaction history reception module;
an automatic card transaction history transmission module which transmits the card transaction history stored in the card transaction history storage module to the card management server; and
a card transaction history synchronization module which receives the card transaction history from the card management server and renews and synchronizes the received card transaction history with the card transaction history storage module,
wherein the card transaction history reading module is configured to automatically read the expenses history, benefits usage history, or donations usage history by using the usage history category or the uses which were previously tracked by the public interest corporation terminal or the government agency terminal as well as the expenses history and date which the company terminal tracks in advance,
wherein the card management server comprises:
a donations-deposits mapping module which maps the donations of the donor with the deposits; and a donor notification module which provides the donor's donor terminal with the card transaction history corresponding to the deposits mapped by the donations-deposits mapping module in real-time,
wherein the card transaction history transmission module is configured to transmit the card transaction history designated as the benefits usage history manually by the beneficiary among the card transaction history stored in the card transaction history storage module to the card management server,
wherein the card transaction history synchronization module is configured to receive the card transaction history manually designated from the card management server, renew the received card transaction history in the card transaction history storage module, and perform the reverse synchronization.
